(19) United States
(12) Patent Application Publication
(10) Pub. No.: US 2007/0180689 A1
(43) Pub. Date: Aug. 9, 2007

(54) Nonazeotropic terpineol-based spray suspensions for the deposition of electrolytes and electrodes and electrochemical cells including the same

(76) Inventors: Michael J. Day, Dublin, OH (US); Matthew M. Seabaugh, Columbus, OH (US)

Correspondence Address: Porter, Wright, Morris & Arthur LLP;IP DOCKETING, Attn: Charma Murphy, 28th Floor, 41 South High St., Columbus, OH, 43215-6194, US

(21) Appl. No.: 11/349,733

(22) Filed: Feb. 8, 2006

(51) Int. Cl. H01M 10/04; C04B 35/64; B05D 5/12

(52) U.S. Cl. 29/623.5; 264/618; 427/126.3; 427/115

(57) ABSTRACT

A family of spray suspensions for aerosol deposition of green ceramic layers that subsequently can be sintered to produce both dense and porous ceramic layers. The suspensions comprise a nonazeotropic solvent mixture, a ceramic powder, a dispersant, and a an organic binder. The invention also includes methods for depositing coatings of these ceramic suspensions on a substrate, either singly or sequentially, to form electrochemically efficient multilayer structures that can be economically co-sintered. The suspensions and deposition approach allow formation of thin layers of varying microstructure and composition in the sintered state. The suspensions and deposition approach are likely to be useful in the fabrication of electrochemical devices.

### STATEMENT REGARDING FEDERALLY SPONSORED RESEARCH

This invention was made with government support under Contract No. DE-FG02-03ER83729 awarded by the United States Department of Energy. The United States Government has certain rights in this invention.

### CROSS-REFERENCE TO RELATED APPLICATIONS

Not applicable

### REFERENCE TO MICROFICHE APPENDIX

Not applicable

### FIELD OF THE INVENTION

This invention relates to spray suspensions for aerosol deposition of ceramic materials. The suspensions and deposition approach may be useful in the fabrication of electrochemical devices.

### BACKGROUND OF THE INVENTION

Solid oxide fuel cells (SOFCs) generate power using multilayer ceramic cells, each of which comprises porous anode, dense electrolyte, and porous cathode layers. Power generation in SOFCs involves the conversion of oxygen molecules (from air) to oxygen ions at the cathode, conductance of oxygen ions through the electrolyte, and reaction of these oxygen ions with fuel to form hydrogen and carbon dioxide. SOFCs typically operate at high temperatures (e.g., 900 to 1000° C.).

SOFC systems operating with natural gas as a fuel can achieve power generation efficiencies in the range of 40 to 45 percent. Hybrid systems, which combine solid oxide fuel cells and gas turbines, can achieve efficiencies of up to 70 percent. Field tests of SOFC systems for stationary, megawatt-scale power systems operating on natural gas have demonstrated exceptional reliability, with degradation rates less than 0.1 percent per decade over thousands of hours of operation. Such SOFC systems are expensive, with projected installed costs of $1500/kW.

The most advanced SOFC technologies now available resulted from demonstrations and market applications that could tolerate premium pricing; intrinsically high cost manufacturing processes often were used to achieve short-term technical goals without cost restrictions. Considerable cost reductions in fuel cell systems must occur as manufacturing processes are scaled up to support mass-market adoption of the technology. For example, an early SOFC manufacturing process used electrochemical vapor deposition (EVD) to form the electrolyte layer. The EVD process is inherently expensive and unlikely to satisfy cost targets for mass-market applications.

As the cost of SOFC power generation is reduced, fuel cell systems become attractive options for several smaller-scale (5-20 kW) power generation applications within various residential, transportation, industrial, and military market segments. Material and design approaches being pursued to reduce the cost of SOFC systems include increasing power density, either through use of innovative stack designs or reduction of resistive losses in a cell.

The most effective cost reduction approaches generally are based on reducing cell and stack manufacturing costs through innovative ceramic processing methods. An example of this approach is replacement of EVD application of electrolytes on tubular SOFCs with less expensive approaches, such as particulate coating/sintering methods.

Electrolyte deposition is a cell manufacturing step fraught with difficulty. The electrolyte must be dense, very thin (e.g., 5-20 μm), and bridge voids of up to 20 μm in diameter in the support electrode. Deposition techniques must tolerate surface roughness and defects while remaining cost effective.

A number of approaches have been used to produce SOFCs in laboratories around the world, as shown in Table 1. The most common coating routes include electrochemical vapor deposition, tape calendaring, tape casting, and screen printing.

TABLE 1

| Processing Route | Advantages | Disadvantages |
|---|---|---|
| Vapor Deposition | Excellent film quality, | High temperature, high capital cost, |
| | geometric flexibility | corrosive precursors |
| Tape Casting | High Throughput, established | Limited to planar geometries, limited to |
| | method, economical | thickness >10 μm, requires co-sintering |
| Tape Calendaring | High throughput, established | Limited to planar geometries, requires |
| | method, economical | co-sintering, many control parameters |
| Dip Slurry Coating | Economical, scalable, | Multiple processing steps required |
| | geometric flexibility | Requires co-sintering, slow |
| Screen Printing | High throughput, economical | Limited to planar geometries, requires |
| | | co-sintering |
| Spin Coating | High throughput, established | Multiple steps required to achieve 5-μm |
| | method, low temperature | thicknesses, requires smooth substrate, |
| | process | many process parameters |
| Thermal Spray | High deposition rates, | Moderately expensive equipment, |
| Deposition | demonstrated scalability, | limited compositional/morphological |
| | geometric flexibility | control, subsequent sintering step |
| | | needed, significant material loss |
| Aerosol Spray | Cost effective, low material | Requires co-sintering, less mature |
| Deposition | loss, geometric/compositional | |
| | flexibility, high throughput | |

Each of the coating methods listed in Table 1 has advantages and disadvantages. Electrochemical vapor deposition has an unparalleled ability to seal and grow YSZ layers of controlled thickness on any number of geometries but the cost of capital equipment required to scale this technique is prohibitive. Tape-based and screen printing methods are most suited to planar geometries, which limit their usefulness in cold-end-seal (tubular) designs. Efforts to reduce electrolyte thicknesses present a particular challenge with tape-based and screen printing methods because prevention of pinhole defects becomes more difficult. Dip slurry coating is suitable for use with nonplanar geometries but requires the use and subsequent removal of large quantities of solvent. The amounts of solvent required adversely affect the microstructure of the resulting coating, limiting the green density that can be obtained.

Spray deposition is a highly flexible method for building SOFC structures and this process can accommodate both planar and tubular substrates. Two spray methods, plasma spray and colloidal spray deposition, commonly are used. Plasma spray deposition originally was developed for oxide coating of turbine blades and other high temperature metal structures. In this process, a coarse metal or oxide powder is fed into a high temperature flame or plasma, where it partially melts. The semi-molten material is projected onto the substrate to be coated, where it deforms on impact and cools. As particles impact the surface, a relatively coarse coating builds up. For uniform coating, the powder feed must be free-flowing and dense to assure that material feeds steadily through the plasma. Fused oxides having a particle size of about 40-100 microns are most commonly used. Plasma spray systems are particularly useful for refractory materials and have been the most widely used for SOFC fabrication.

Plasma spray systems may be operated under vacuum (VPS), low pressure (LPPS), or atmospheric pressure (APS). This results in lower system cost than EVD or other vapor or chemical based routes, although this cost is higher than that of aerosol spray methods. Electrolyte layers have been deposited on metal anode, cermet anode, and cathode substrates using plasma spray systems. The resulting electrolyte layers may have densities greater than 95%, but they are not always gas tight, typically as a result of pinhole or microcrack formation. Conventional plasma spray systems generally require subsequent high-temperature sintering steps (T>1400° C.) to assure densification of the electrolyte layer. SOFC structures with NiO—YSZ anode, YSZ electrolyte, and LSM cathode layers have been formed using multiple plasma spray steps. However, electrode layers formed by plasma spray deposition have exhibited porosity levels of less than 20 percent. As a result, the thickness of the electrode layers applied by plasma spray deposition must be reduced, allowing increased gas permeability at the expense of increased cell resistance.

Aerosol spray deposition also has been evaluated on an industrial scale. In this method, a highly dispersed suspension of ceramic powder is deposited by atomization onto the substrate and the deposited layer is then sintered to achieve high density. Aerosol spray deposition has several advantages over plasma spray deposition. The equipment cost is very low and can be designed to minimize overspray. Over-sprayed aerosol solution can also be recycled while over-sprayed plasma spray material is effectively lost. Aerosol deposited films exhibit minimal porosity after sintering, in contrast to the coarse microstructure of plasma-sprayed films, which may require high sintering processes to achieve gas-tight films. While it may be possible to achieve dense plasma-spray films without a subsequent densification step, ceramic-supported SOFC electrolytes require that the support electrode be sintered prior to electrolyte deposition. Under appropriate conditions, aerosol deposited electrolytes can be co-sintered at the same time as their electrode supports, which reduces production cost.

Aerosol spray deposition also offers much greater flexibility in microstructure control. The microstructure and composition of the electrode layers play a critical role in determining the interfacial resistance and overall cell performance of SOFCs. Finely mixed composite structures exhibit superior performance over more coarsely mixed materials. Plasma spray processes produce only dense composite cathodes or cathode interlayers with very coarse distribution of the two component phases. Aerosol spray deposition relies on much finer powder during deposition and can be used to apply very fine, highly dispersed composites with a range of density values. The inclusion of fugitive materials and control of particle size in the spray suspension, active films with a range of densities and pore distributions can be controllably deposited.

### SUMMARY OF THE INVENTION

The present invention provides a spray suspension for electrolyte, cathode and anode material particles. The spray suspension allows aerosol deposition of green ceramic layers that subsequently can be sintered to produce both dense and porous ceramic layers. The suspensions and deposition approach allow formation of thin layers of varying microstructure and composition in the sintered state. The suspensions and deposition approach are likely to be useful in the fabrication of electrochemical systems, including but not limited to solid oxide fuel cells, solid oxide electrolyzers, ceramic oxygen generation systems, and ceramic membrane reactors.

The suspension of the present invention include two solvents combined at a highly nonazeotropic ratio, a ceramic powder, an organic binder, and a dispersant. The more volatile majority solvent is selected to evaporate before the atomized drops of the suspension impact the sprayed surface while the less volatile minority solvent is selected for its ability to solvate the binder and the dispersant. Preferably, the minority solvent also contributes to the leveling of the as-sprayed film. This suspension is particularly well-suited for use in spray coating applications

The present invention also includes methods for depositing coating of these ceramic suspension on a substrate, either singly or sequentially, to form electrochemically efficient multilayer structures that can be economically co-sintered. The coatings preferably are applied by spray coating. The invention also provides multilayer products formed using these materials and coating methods.

The present invention provides a ceramic spray suspension. In one embodiment, the ceramic spray suspension comprises a minority terpineol-based solvent, a majority organic solvent having a vapor pressure higher than the vapor pressure of terpineol, an organic binder, a dispersant, and a powdered ceramic composition selected from an electrolyte material and an electrode material. The minority solvent preferably comprises terpineol, the binder preferably comprises ethyl cellulose, and the majority solvent preferably comprises acetone or a non-terpineol alcohol. The ceramic composition may be an electrolyte material selected from a stabilized zirconia composition, a doped ceria composition, a doped lanthanum gallate, a doped alkaline earth cerate, a doped alkaline earth zirconate, a bismuth oxide, or mixtures thereof. Alternatively, the ceramic material may be an electrode material selected from a nickel oxide/doped zirconia composite, a nickel oxide doped ceria, a mixture of nickel oxide/doped ceria materials, a lanthanum strontium manganite, a lanthanum strontium ferrite, a lanthanum strontium nickelate, a lanthanum strontium cobaltite, or a mixture thereof.

The invention provides methods of coating various substrates. In one embodiment, a method of coating a porous substrate comprises the steps of providing a porous substrate, applying a coating of the above-described ceramic spray suspension to the substrate; applying a second coating of the ceramic spray suspension to the coated substrate, and co-sintering the coated substrate. The powdered ceramic composition may be an electrolyte material. Preferably, the coating steps are carried out by spray coating. The ceramic suspension may be applied at a thickness sufficient to produce a coating at least 15 microns thick after sintering.

In another embodiment, a method of coating a previously coated substrate comprises the steps of providing a coated substrate and applying a coating of the above-described ceramic spray suspension to the coated substrate. Preferably, the coating step is carried out by spray coating.

In yet another embodiment, a method of coating a porous ceramic substrate comprises the steps of providing a porous ceramic substrate, applying a first coating of an above-described ceramic suspension to the substrate, applying a second coating of an above-described ceramic suspension to the coated substrate, and co-sintering the coated substrate. The powdered ceramic composition of the first and second ceramic suspensions each may comprises an electrolyte material or an electrode material, with the step of applying the second coating being carried out while the first coating is wet. Alternatively, the powdered ceramic composition of the first ceramic suspension may comprise an electrode material and the powdered ceramic composition of the second ceramic suspension may comprise an electrolyte material, with the step of applying the second coating being carried out after the first coating has dried or has dried and been fired.

In still another embodiment, a method of coating a porous electrode comprises the steps of providing a porous electrode; applying a coating of a ceramic suspension to the substrate, with the powdered ceramic composition comprising an electrode interlayer material having a polarity corresponding to the polarity of the porous electrode; drying the coated substrate; applying a coating of a second ceramic suspension to the coated substrate, with the powdered ceramic composition of the second suspension comprising an electrolyte material; and co-sintering the coated substrate. Preferably, the coating steps are carried out by spray coating and the electrolyte suspension and the electrode suspension each is applied at a thickness sufficient to produce a layer at least 15 microns thick after sintering. The method further may comprise the step of applying a second coating of the second suspension to the electrolyte coating before co-sintering the coated substrate or the steps of applying a second coating of the second suspension to the electrolyte coating after co-sintering the coated substrate and sintering the re-coated substrate.

The invention also provides a method of making an electrochemical cell. The method comprises the steps of providing a porous electrode; applying a coating of a ceramic suspension to the electrode, with the powdered ceramic composition comprising an electrode interlayer material having a polarity corresponding to the polarity of the porous electrode; drying the coated electrode; applying a coating of a second ceramic suspension to the coated electrode, with the powdered ceramic composition of the second suspension comprising an electrolyte material; drying the electrolyte-coated electrode; applying a coating of a third ceramic suspension to the electrolyte-coated electrode, with the powdered ceramic composition of the third suspension comprising an electrode interlayer material having a polarity opposite the polarity of the porous electrode; applying a coating of a fourth ceramic suspension to the electrode interlayer-coated electrode, with the powdered ceramic composition of the fourth suspension comprising a current-carrying electrode material having a polarity opposite the polarity of the porous electrode; and co-sintering the coated electrode. The method further may comprise the step of selecting an unsintered porous electrode.

### BRIEF DESCRIPTION OF THE DRAWINGS

These and further objects of the invention will become apparent from the following detailed description.

FIG. 1 is a secondary electron image scanning electron microscope (SEM) micrograph of an electrolyte-coated cathode tube without interlayer sintered at 1300° C.

FIG. 2 is a backscatter image SEM micrograph of the electrolyte coated cathode tube of FIG. 1.

FIG. 3 is a secondary electron image SEM micrograph of an electrolyte coated cathode tube with LSM/GDC interlayer sintered at 1300° C.

FIG. 4 is a backscatter image SEM micrograph of the electrolyte coated cathode tube of FIG. 3.

FIG. 5 is a secondary electron image SEM micrograph of an electrolyte-coated cathode tube with LSM/GDC interlayer sintered at 1350° C.

FIG. 6 is a backscatter image SEM micrograph of the electrolyte coated cathode tube of FIG. 5.

FIG. 7 is an SEM micrograph of an electrolyte-coated anode tube sintered for two hours at 1300° C.

FIG. 8 is an SEM micrograph of an electrolyte coated anode tube identical to the tube of FIG. 7 sintered for two hours at 1350° C.

FIG. 9 is an SEM micrograph of an electrolyte coated anode tube identical to the tube of FIG. 7 sintered for two hours at 1400° C.

FIG. 10 is a secondary electron image SEM micrograph of a current-carrying anode support tube with multiple layers deposited by aerosol spraying (active anode layer, electrolyte, active cathode interlayer, and current collector cathode layer) and then sintered at 1350° C.

FIG. 11 is a backscatter image SEM micrograph of the current-carrying anode support tube of FIG. 10.

### DETAILED DESCRIPTION OF CERTAIN PREFERRED EMBODIMENTS

The present invention provides a family of spray suspensions for electrolyte, cathode and anode material particles. The spray suspensions are designed for aerosol deposition of green ceramic layers that subsequently can be sintered to produce both dense and porous ceramic layers. The suspensions and deposition approach allow formation of thin layers of varying microstructure and composition in the sintered state. The suspensions and deposition approach are likely to be useful in the fabrication of electrochemical systems, including but not limited to solid oxide fuel cells, solid oxide electrolyzers, ceramic oxygen generation systems, and ceramic membrane reactors.

The suspension of the present invention include two solvents combined at a highly nonazeotropic ratio, a ceramic powder, an organic binder, and a dispersant. The more volatile majority solvent is selected to evaporate before the atomized drops of the suspension impact the sprayed surface while the less volatile minority solvent is selected for its ability to solvate the binder and the dispersant. Preferably, the minority solvent also contributes to the leveling of the as-sprayed film. This suspension is particularly well-suited for use in spray coating applications

The two-part nonazeotropic solvent system comprises a majority solvent and a minority solvent (based on volume). The majority solvent is a low viscosity, high vapor pressure liquid, including but not limited to acetone, ethanol, and other organic solvents and combinations of these. This solvent is present in the suspension before atomization but is selected to evaporate before the atomized droplets impact the sprayed surface. The minority solvent is a high viscosity, low vapor pressure solvent in which the binder and dispersant are soluble. The minority solvent preferably exhibits leveling during the drying process—that is, it allows settling and rearrangement of the film during drying and ameliorates drying stresses. Solvents that dry uniformly through without the formation of a dry skin at the liquid/gas interface are particularly suitable. Terpineol is a particularly preferred minority solvent because it has both polar and nonpolar character and therefore provides effective interaction with both organic materials and ceramic powders. It also has a high viscosity and a low vapor pressure, dries uniformly without skinning, and is generally considered to be an environmentally safe solvent. Other solvents, including pine oil-derived solvents, may yield satisfactory results as minority solvents if they possess certain properties, namely, viscosity, vapor pressure, polymer solubility, and drying characteristics, similar to those of terpineol. As used herein, “terpineol-based solvent” refers to terpineol, another solvent having the above described properties, or a combination of these.

The majority solvent has a lower viscosity and higher vapor pressure than the terpineol-based solvent, so the terpineol-based solvent evaporates more slowly from the deposited film. The high viscosity and low vapor pressure of the terpineol-based solvent mediate controlled drying of the deposited film on the substrate. The controlled drying of the terpineol-based solvent allows rearrangement of particles prior to drying and amelioration of drying stresses. The terpineol-based spray suspensions of the present invention typically take about 15 minutes to dry at a temperature of 100° C.

The organic binder must be soluble in the minority solvent. The organic binder preferably comprises ethyl cellulose but other organic materials including but not limited to acetates also may yield satisfactory results. In one embodiment, a commercially-available screen-printing vehicle (e.g., Johnson Matthey 63/2 medium), may provide a suitable minority solvent and binder combination. The dispersant may be Hypermer KD-1 dispersant, menhaden fish oil, or any other material capable of enhancing particle dispersion through steric, electrosteric, or electrostatic forces.

Ceramic electrolyte materials useful in the ceramic suspensions of the present invention may include fully or partially stabilized zirconia compositions, more preferably yttrium-doped zirconias, scandium-doped zirconias, doped cerias, doped lanthanum gallates, doped alkaline earth cerates, doped alkaline earth zirconate, bismuth oxides, and mixtures of these. The compositions may vary from one layer to another to form a composite electrolyte.

Ceramic electrode materials useful in the spray suspensions of the present invention may include nickel oxide/doped zirconia composites, nickel oxide doped ceria, a mixture of nickel oxide/doped ceria material, lanthanum strontium manganites, lanthanum strontium ferrites, lanthanum strontium nickelates, lanthanum strontium cobaltites, metals such as ferritic stainless steel, metal alloys such as nickel-based alloys, and mixtures of these. The compositions may vary from one layer to another to form a composite electrode.

The composition of the organic components of the spray suspension may vary depending on the ceramic powder composition. Preferably, the system comprises 30-70 wt. % ceramic oxide. This amount varies widely depending upon the surface area of the powder (fine, high surface area powders may interact significantly more than coarse powders, which could lead to settling), the density of the ceramic powders (dense powders may have high solids content at equivalent volumetric solids loadings), and the spray conditions (low solids content suspensions provide the ability to apply thinner layers but require multiple deposition steps while high solid content suspension provide the ability to apply thicker layers in a single spray process). The minority terpineol-based solvent preferably comprises 10-30 wt. % of the suspension, preferably about 16 wt. %. The majority (diluent) solvent, which makes up the balance of the spray suspension, is present in an amount by volume greater than the amount by volume of the terpineol-based solvent. The majority solvent reduces the viscosity of the spray suspension to a desired level and mediates dispersion of the slurry during deposition.

The ceramic suspension of the present invention is well-suited to coating porous or dense layers. The system has high viscosity and solids loading, which allows the films to bridge pores in porous substrates effectively. The system also has wetting behavior that allows effective coating of dense substrates.

Generally, the disclosed ceramic suspension and coating methods are material independent. A wide variety of anodes, cathode, electrolytes, and other ceramic powders may be used with the ceramic spray suspension of the present invention. Porous substrates useful in the practice of the spray coating application method may be unsintered, partially sintered, or sintered ceramics, metals, or electrochemically inert materials. The use of unsintered substrates, when appropriate, eliminates a firing cycle. Lanthanum strontium manganites and nickel oxide/doped zirconia compositions are preferred substrates.

Electrode and electrolyte powder suspensions of the present invention may be applied to substrates by several methods, including brush painting, banding, and screen printing, among others. However, spray coating is a preferred method because it offers the greatest geometric flexibility and utility. Various approaches may be used to create the spray, including without limitation aerosol and ultrasonic atomization. Spray coating using either aerosol or ultrasonic atomization provides films that can be deposited controllably in layers as thin as 10 microns.

When the ceramic suspension is used in spray coating applications, the majority solvent also mediates atomization of the slurry. While not wishing to be bound by theory, the majority solvent is thought to almost completely vaporize before the spray droplets impact the substrate and form a film. The film deposited on the substrate consists essentially of the ceramic powder, the minority solvent, the dispersant, and the organic binder. The rapid vaporization of the majority solvent avoids the need to remove large quantities of majority solvent from the deposited film and allows achievement of higher green densities at the deposition step compared to conventional dip slurry coating methods.

When applied by spray deposition, the ceramic suspension of the present invention provides a relatively viscous film that dries gradually. This results in “leveling” of the film, meaning that the coating tends to flow to reduce inhomogeneities in film thickness, resulting in a smooth, uniform coating with little or no dripping, running, or sagging. The gradual drying of the terpineol-based solvent allows the film to adjust to drying stresses as they occur. The presence in the spray suspension of ethyl cellulose or an organic binder with similar properties contributes to the strength of the dried coatings. The viscosity of the spray suspension may be adjusted as needed before application by adding additional amounts of the majority solvent, minority solvent, terpineol-based binder system (e.g., a screen printing ink) or a combination of these.

The spray-coating application method of the present invention provides a noncontact method for depositing a film of an electrochemically active material on a substrate. This avoids the risk that materials from the substrate will be picked up by the screen printing or other applicator. The noncontact application method also avoids damage to fragile substrates because physical force need not be applied to the substrate during coating. In addition, spray coating allows for deposition of films on substrates having nonplanar or other complex geometries, unlike screen printing, which generally is suitable for use only with planar substrates. In particular, spray coating allows application of film coating to fragile, tubular substrates such as bisque-fired tubes.

The spray-coating method of the present invention offers several advantages. Electrolytes applied by spray coating may be co-sintered at the same time as their electrode supports, which reduces production cost.

Spray coating also allows sequential spray deposition of multiple layers of ceramic materials having the same or different composition, which may then be fired together to achieve simultaneous densification. The ability to deposit two or more functional layers or layer thicknesses within a single firing cycle reduces manufacturing cost. This process may be used whether or not shrinkage of the underlying substrate is likely during heat treatment. The disclosed co-sintering method is suitable for use with a wide range of materials; however, achievement of the desired microstructure requires that the layers be chemically compatible and demonstrate targeted shrinkage behavior to maintain layer integrity. The deposition of multiple layers of ceramic coatings before a single firing step may be desired when applying (1) electrolyte and electrode layers, (2) multiple layers of an electrolyte coating to repair or reduce the likelihood of surface defects, or (3) multiple layers of different electrode compositions (e.g., porous and dense) having well-matched sintering characteristics.

When electrolyte and electrode layers are to be deposited sequentially without an intermediate firing step, both the electrode and electrolyte suspensions preferably include a terpineol-based minority solvent and a common binder. After applying an initial coating layer, allowing time for the terpineol-based solvent to dry (about 15 minutes at 100° C.) and an additional cooling time (typically about 5 minutes), secondary layers may be applied with no observed detrimental interactions with the initial layers. For example, a cathode tube may be coated with both a cathode interlayer and then an electrolyte layer before sintering. Such a multi-component coating is not achievable using conventional aqueous coating systems, which require intermediate calcination steps to maintain electrolyte and active electrode layer integrity and achieve suitable surface wetting. Drying is required between electrolyte and electrode layers to avoid chemical interactions at the interface.

Multiple thicknesses of a single suspension composition also may be applied sequentially, with or without intermediate sintering steps. Drying between layer application may or may not be required for satisfactory co-sintering results. The application of multiple thicknesses of a one or more electrolyte composition would most likely occur because of the difficulties associated with electrolyte deposition. The two-part nonazeotropic ceramic suspension of the present invention provides sufficient wetting to allow application of sequential layers of an electrolyte suspension even after sintering of a previously-applied layer of electrolyte suspension. This cannot be accomplished with conventional aqueous suspensions, which are incapable of adequately wetting a dense (sintered) zirconia electrolyte coating. The present invention therefore provides advantages in the preparation of thin, defect-free electrolyte coatings or the recoating of electrolyte coatings that may not be defect-free.

Multiple thicknesses of different compositions also may be applied to form composite layers. The composition of the layers may vary provided the layers have similar densities after firing.

The examples below describe preparation of a Sc-doped zirconia electrolyte material, nickel-oxide/zirconia composite anode materials, and lanthanum manganite/Gd-doped ceria cathode materials. However, as described above, a range of analogous anodes, cathodes, and electrolytes or other ceramic powders could be substituted for the materials in the examples.

### EXAMPLE 1

### Preparation of Electrolyte Spray Suspension

In a 1 liter Nalgene bottle, 250 ml of 1 cm diameter zirconia media and 100 ml of acetone were added to 2.25 g Hypermer KD-1 dispersant. This material was placed on a vibratory mill for 10 minutes to completely dissolve the dispersant. To this solution, 150 g Daiichi ZrO₂-6 mol % Sc₂O₃-1 mol % Al₂O₃ powder was added. The resultant slurry was returned to the vibratory mill for 24 hours to assure complete deagglomeration of the powder. The slurry was poured into a 1 liter Pyrex beaker and the solvent allowed to evaporate at 60° C. until half the initial volume of the slurry was reached. To this mixture, 80.85 g terpineol-based screen-printing vehicle (Johnson Matthey 63/2, medium grade) was added and stirring continued. When the slurry was again homogenized, the slow evaporation at 60° C. was resumed and continued until the specific gravity of the suspension reached 1.3 g/cm³. Small amounts of terpineol, a terpineol-based solvent or binder system, or the majority solvent may be added to the prepared suspension as needed to reduce the suspension viscosity for aerosol or ultrasonic atomization.

### EXAMPLE 2

### Preparation of Electrode Spray Suspension

In a 1 liter Nalgene bottle, 250 ml of 1 cm diameter zirconia media and 100 ml of acetone were added to 0.41 g Hypermer KD-1 dispersant. This material was placed on a vibratory mill for 10 minutes to completely dissolve the dispersant. To this solution, ˜125 g of cathode or anode composite powder was added. The resultant slurry was returned to the vibratory mill for 24 hours to assure complete deagglomeration of the powder. The slurry was poured into a Pyrex pan and the solvent allowed to evaporate in a convection oven held at 60° C. until dried. The powder was then sieved through a 60 mesh screen. 50 g powder was slowly added to 15 g terpineol-based screen printing vehicle (Johnson Matthey 63/2 medium) using an ultrasonic wand. The slurry was ultrasonicated for 15 minutes. Small amounts of terpineol, a terpineol-based solvent or binder system, or the majority solvent may be added to the prepared suspension as needed to reduce the suspension viscosity for aerosol or ultrasonic atomization.

### EXAMPLE 3

### Electrolyte Deposition on Cathode Substrate

A coating of the electrolyte spray suspension was applied to a previously sintered lanthanum manganite-based cathode tube using a small airbrush. The electrolyte suspension as applied at a thickness sufficient to produce a coating 15 μm thick and then sintered at 1300° C. for one hour.

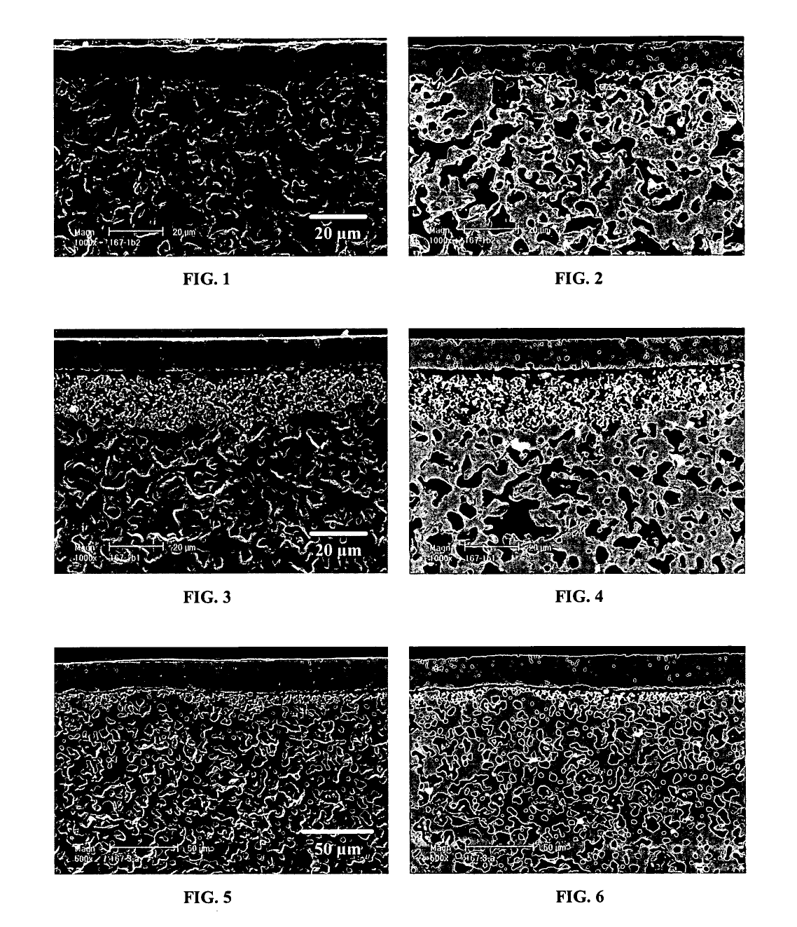

The resultant microstructure is shown in FIGS. 1 and 2. As can be seen in the micrographs, penetration of the film into the substrate was minimal due to the relatively high viscosity of the suspension.

### EXAMPLE 4

### Electrolyte/Interlayer Deposition on Cathode Substrate

A coating of the active cathode (lanthanum strontium manganite/gadolinium-doped ceria) interlayer material was deposited on a previously sintered lanthanum manganite-based cathode tube using a small airbrush. The cathode interlayer suspension was applied at a thickness sufficient to produce a coating 15 μm thick. The tube was dried at 60° C. for 20 minutes, a time sufficient to avoid chemical interaction between the cathode interlayer and the subsequent electrolyte layer. A coating of the electrolyte spray suspension was then applied, again using a small airbrush. The electrolyte suspension was applied at a thickness sufficient to produce a coating 15 μm thick. The sample was then sintered at 1300° C. for one hour.

The resultant microstructure is shown in FIGS. 3 and 4. As can be seen in the micrographs, penetration of the film into the substrate was minimal due to the relatively high viscosity of the suspension. Although this film is slightly porous, the microstructure demonstrates the versatility of the current system for film deposition. The backscatter image shows that the fine scale porosity near the electrolyte surface is associated with an electrochemically active cathode layer, a composite of LSM and GDC powders, which accounts for its slightly brighter color. Such a multi-component coating is not achievable in conventional aqueous coating systems, which require intermediate calcination steps to maintain electrolyte and active electrode layer integrity and achieve suitable surface wetting.

### EXAMPLE 5

### Sequential Coating and Firing with a Second Coating Step

A coating of the cathode (lanthanum strontium manganite/Gd-doped ceria) interlayer material was deposited on a previously sintered lanthanum manganite-based cathode tube using a small airbrush. The cathode interlayer suspension was applied at a thickness sufficient to produce a coating 15 μm thick. The tube was dried at 60° C. for 20 minutes. A coating of the electrolyte spray suspension was then applied at a thickness sufficient to produce a coating 15 μm thick, also using a small airbrush. The resultant sample was then fired at 1350° C. After sintering, a second spray coat of electrolyte material was applied and sintered as described above to repair any defects and achieve better gas tightness. The applied electrolyte layer was ˜20 μm thick after two coatings. FIGS. 5 and 6 show the microstructure of the electrolyte-coated cathode tube.

### EXAMPLE 6

### Electrolyte/Interlayer Deposition on Anode Substrates

A suspension of anode (nickel oxide/Gd-doped ceria) interlayer material was deposited on a previously sintered anode (nickel oxide/yttria-stabilized zirconia) tube using a small airbrush. The anode interlayer suspension was applied at a thickness sufficient to produce a coating 15 μm thick. The tube was dried at 60° C. for 20 minutes. A coating of the electrolyte spray suspension was then applied, again using a small air brush. The electrolyte suspension was applied at a thickness sufficient to produce a coating 15 μm thick. Samples were sintered at several temperatures.

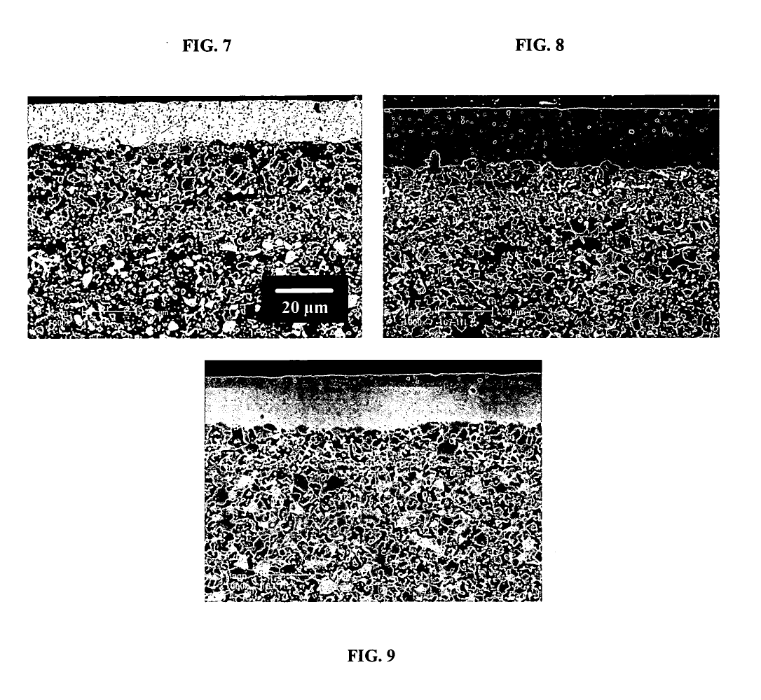

FIGS. 7-9 are backscatter image SEM micrographs from samples sintered at 1300, 1350, and 1400° C. These micrographs show the impact of sintering temperature not only on electrolyte densification, but also on the active anode layer and the current carrying anode layer. Extremely dense electrolyte layers are apparent at both 1350 and 1400° C. Densification is less complete in the electrolyte and active anode layers at 1300° C., but at this temperature the sintering shrinkage of the tube itself is nearly 5 linear percent less, which would constrain film shrinkage and densification.

### EXAMPLE 7

### Complete Cell Deposition

To complete the fabrication of an entire cell, four layers were applied to an NiO/YSZ tube. First, the anode interlayer and electrolyte layer were deposited as described in Example 6. Two additional layers were then applied sequentially using a small airbrush: an active cathode (lanthanum strontium manganite/Gd-doped ceria) interlayer and a layer of current carrying cathode (LSM). These suspensions were applied to achieve a thickness of 15 μm each. The tube coated with the four layers was sintered at 1350° C.

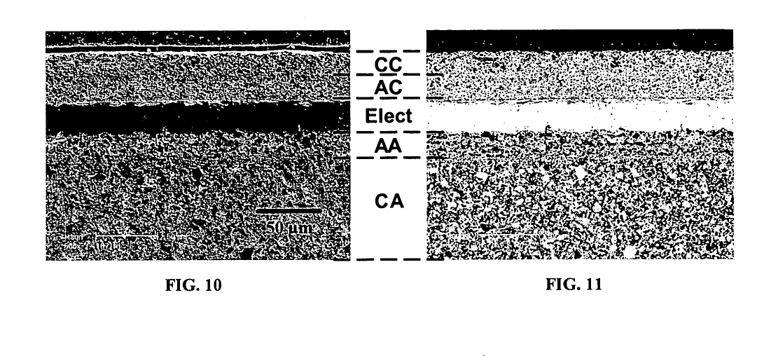

The SEM micrograph of FIG. 10 shows the five layers of the resultant cell—the current carrying cathode (LSM) layer, the active cathode (LSM/GDC) layer, the electrolyte, the active anode (NiO/GDC), and the current carrying anode support tube. The backscatter image, FIG. 11, shows the compositional shift between the active anode and the support tube and highlights the density of the electrolyte sintered at 1350° C.

A complete cell may be fabricated by a process analogous to that described in Example 7 using a cathode tube substrate if an electrode composition with a filing temperature that avoids interaction between the electrolyte and the cathode can be identified. The same general approach may be used for a wide range of layer compositions, including deposition of dissimilar, 50% dense electrode layers to completely dense electrolyte layers.

The unique nature of the suspension development of the present invention is evident in the control of porosity, chemistry, and phase distribution in the layers. The present invention achieves a continuous network of electrode and electrolyte phases on both anode and cathode substrates.

The preferred embodiment of this invention can be achieved by many techniques and methods known to persons who are skilled in this field. To those skilled and knowledgeable in the arts to which the present invention pertains, many widely differing embodiments will be suggested by the foregoing without departing from the intent and scope of the present invention. The descriptions and disclosures herein are intended solely for purposes of illustration and should not be construed as limiting the scope of the present invention which is described by the following claims.

What is claimed is:

1. A ceramic spray suspension, comprising:
a minority terpineol-based solvent;
a majority organic solvent having a vapor pressure higher than the vapor pressure of terpineol;
an organic binder;
a dispersant; and
a powdered ceramic composition selected from an electrolyte material and an electrode material.

2. The ceramic spray suspension of claim 1, wherein the terpineol-based solvent comprises terpineol.

3. The ceramic spray suspension of claim 1, wherein the binder comprises ethyl cellulose.

4. The ceramic spray suspension of claim 1, wherein the ceramic composition comprises an electrolyte material selected from a stabilized zirconia composition, a doped ceria composition, a doped lanthanum gallate, a doped alkaline earth cerate, a doped alkaline earth zirconate, a bismuth oxide, and mixtures thereof.

5. The ceramic spray suspension of claim 1, wherein the ceramic material comprises an electrode material selected from a nickel oxide/doped zirconia composite, a nickel oxide doped ceria, a mixture of nickel oxide/doped ceria materials, a lanthanum strontium manganite, a lanthanum strontium ferrite, a lanthanum strontium nickelate, a lanthanum strontium cobaltite, and mixtures thereof.

6. The ceramic suspension of claim 1, wherein the majority solvent is selected from acetone and a non-terpineol alcohol.

7. A method of coating a porous substrate, the method comprising the steps of:
providing a porous substrate;
applying a coating of a ceramic spray suspension according to claim 1 to the substrate;
applying a second coating of the ceramic spray suspension to the coated substrate; and
co-sintering the coated substrate.

8. The method of claim 7, wherein the powdered ceramic composition is an electrolyte material.

9. The method of claim 7, wherein the coating steps are carried out by spray coating.

10. The method of claim 9, wherein the ceramic suspension is applied at a thickness sufficient to produce a coating at least 15 microns thick after sintering.

11. A method of coating a previously coated substrate, the method comprising the steps of:
providing a coated substrate;
applying a coating of a ceramic spray suspension according to claim 1 to the coated substrate.

12. The method of claim 11, wherein the coating step is carried out by spray coating.

13. A method of coating a porous ceramic substrate, the method comprising the steps of:
providing a porous ceramic substrate;
applying a first coating of a ceramic suspension according to claim 1 to the substrate;
applying a second coating of a ceramic suspension according to claim 1 to the coated substrate; and
co-sintering the coated substrate.

14. The method of claim 13, wherein the powdered ceramic composition of the first and second ceramic suspensions each comprises an electrolyte material and the step of applying the second coating is carried out while the first coating is wet.

15. The method of claim 13, wherein the powdered ceramic composition of the first and second ceramic suspensions each comprises an electrode material and the step of applying the second coating is carried out while the first coating is wet.

16. The method of claim 13, wherein the powdered ceramic composition of the first ceramic suspension comprises an electrode material, the powdered ceramic composition of the second ceramic suspension comprises an electrolyte material, and the step of applying the second coating is carried out after the first coating has dried.

17. The method of claim 13, wherein the powdered ceramic composition of the first ceramic suspension comprises an electrode material, the powdered ceramic composition of the second ceramic suspension comprises an electrolyte material, and the step of applying the second coating is carried out after the first coating has dried and been fired.

18. A method of coating a porous electrode, the method comprising the steps of:
providing a porous electrode;
applying a coating of a ceramic suspension according to claim 1 to the substrate, the powdered ceramic composition comprising an electrode interlayer material having a polarity corresponding to the polarity of the porous electrode;
drying the coated substrate;
applying a coating of a second ceramic suspension according to claim 1 to the coated substrate, the powdered ceramic composition of the second suspension comprising an electrolyte material; and
co-sintering the coated substrate.

19. The method of claim 18, wherein the coating steps are carried out by spray coating and the electrolyte suspension and the electrode suspension each is applied at a thickness sufficient to produce a layer at least 15 microns thick after sintering.

20. The method of claim 18, further comprising the step of:
applying a second coating of the second suspension to the electrolyte coating before co-sintering the coated substrate.

21. The method of claim 18, further comprising the steps of:
applying a second coating of the second suspension to the electrolyte coating after co-sintering the coated substrate; and
sintering the re-coated substrate.

22. A method of making an electrochemical cell, the method comprising the steps of:
providing a porous electrode;
applying a coating of a ceramic suspension according to claim 1 to the electrode, the powdered ceramic composition comprising an electrode interlayer material having a polarity corresponding to the polarity of the porous electrode;
drying the coated electrode;
applying a coating of a second ceramic suspension according to claim 1 to the coated electrode, the powdered ceramic composition of the second suspension comprising an electrolyte material;
drying the electrolyte-coated electrode;
applying a coating of a third ceramic suspension according to claim 1 to the electrolyte-coated electrode, the powdered ceramic composition of the third suspension comprising an electrode interlayer material having a polarity opposite the polarity of the porous electrode;
applying a coating of a fourth ceramic suspension according to claim 1 to the electrode interlayer-coated electrode, the powdered ceramic composition of the fourth suspension comprising a current-carrying electrode material having a polarity opposite the polarity of the porous electrode; and
co-sintering the coated electrode.

23. The method of claim 22, further comprising the step of:
selecting an unsintered porous ceramic electrode.
